(19) United States
(12) Patent Application Publication
(10) Pub. No.: US 2022/0138835 A1
(43) Pub. Date: May 5, 2022

(54) SYSTEM AND METHOD OF MY WISH LIST GIFT FULFILLMENT

(71) Applicant: Oanh Hoang Nguyen, Aurora, IL (US)

(72) Inventor: Oanh Hoang Nguyen, Aurora, IL (US)

(21) Appl. No.: 17/084,892

(22) Filed: Oct. 30, 2020

(51) Int. Cl. G06Q 30/06; G06Q 10/08; G06Q 20/34; G06Q 40/02

(52) U.S. Cl. CPC G06Q 30/0635; G06Q 10/083; G06Q 40/02; G06Q 30/0623; G06Q 20/341; G06Q 30/0609

(57) ABSTRACT

A system for facilitating acquisition of items on behalf of a requesting device is provided. The system comprises an application that when executed on a computer publishes a listing of items specified by a first device, the items available from online vendors designated in the specification. The system also receives an instruction from a second device to purchase a first item in the listing of items. The system also purchases, based on the instruction, the first item from a first online vendor of the online vendors, and directs the first online vendor to ship the first item to a specified address. The specified address is provided by the first device. The system further verifies availability and price of the first item with the first online vendor prior to purchasing.

### FIELD OF THE INVENTION

The present disclosure is in the field of electronic transactions. More particularly, the present disclosure provides systems and methods of publishing a list of desired items and invite participants in a group to individually procure and give the desired items to the publisher, with an intermediary system handling all aspects of purchasing and delivering the items.

### BACKGROUND

Persons wishing to receive gifts for birthday, weddings, and other occasions are generally not comfortable approaching potentially generous persons and directly asking for gifts. Friends, relatives and other givers or donors of gifts are generally not comfortable approaching the recipient and directly asking the recipient what they would like for their birthday or other occasion. As a result, frequently a wrong gift is selected for a recipient, a duplicate gift may be selected, or no gift is given, usually innocent mistakes by donors. A potential gift donor may accidentally be left off a donor list.

Giving gifts traditionally involves guessing what the recipient would like, shopping for the gift, and wrapping and sending the gift, often by mail, with the hope that the gift reaches the recipient on time. Each step involves potential pitfalls, especially guessing what the recipient would like. Further, if the gift is the wrong size or color, the gift may need to be returned or may be “regifted.”

Retailers, whether physical retailers or online, may have return policies that are onerous. Retailers may not readily accept an item in return and may not issue a full refund.

### BRIEF DESCRIPTION OF THE FIGURE

FIG. 1 is a block diagram of a system of a My Wish List gift fulfillment in accordance with an embodiment of the present disclosure.

### DETAILED DESCRIPTION

Systems and methods described herein provide for a party using a recipient device to create a “wish list” of desired gifts, publish the list, and enable selected donors to review the list. The selected donors may select gifts from the list to give to the recipient and cause the system to purchase the selected gift(s) using payment information provided by the donors to the system. The system then ships the purchased gift to the recipient at a location specified by the recipient.

The recipient may use an application, recipient app, or “app” executing on a personal mobile device to create a private online venue on a remote hosting server. The venue is accessible only by the recipient and selected prospective donors of gifts desired by the recipient. The recipient explores online vendors of desired gifts and chooses certain desired gifts. Subject to availability and price limitations or guidelines entered by the recipient, the app on the recipient device causes the hosting server to publish information and illustrations describing and displaying the gifts. The recipient device also causes the server to publish delivery address information and hoped-for dates of delivery, such as a date of an upcoming birthday.

For the recipient, the only actions required are to create the venue, choose the desired gifts, choose online vendors, and submit a list of donors who may make purchases. Donors need only access the venue, view the desired gifts, choose at least one, and provide payment information. Donors do not need to visit Internet sites of the online vendors or deal with any shipping or delivery issues.

The recipient device via the app and the server together handle all other significant aspects of the transactions including accessing online vendors, verifying specified availability and price guidelines, making the purchases on behalf of the donors, and arranging delivery of the purchased items to the recipient. The recipient is relieved of needing to personally approach donors, for example relatives, and advise the donors as to what gifts the recipient wants. The recipient merely needs to choose the gifts he/she wants, identify the appropriate online vendors, and list the donors invited to give the gifts to the recipient. The server handles all dealings with the online vendors, with shipping firms, and with the donors.

The donors merely need to access the venue, review the list of desired gifts, choose at least one, and provide their payment details, for example credit card information. The donors need not make direct contact with any of the online vendors or be concerned with shipment and delivery details. The donors need only choose a gift and provide their payment details. The server handles all aspects of the purchase and delivery.

Neither the recipient nor the donor needs to deal directly with online vendors once the recipient has identified the donors and approved price, availability, and shipping arrangements. The donor contacts only the server which handles all interaction with online vendors during transactions.

In an embodiment, a child may be looking forward to an upcoming birthday, for example his sixth birthday, and be interested in several items as potential gifts. The gifts are available from online vendors. All major “brick and mortar” retailers have significant online presences and enable shoppers to fully make purchases from their online stores. Other purely online vendors also make shopping easy for their customers.

The mother of the child in this example uses a mobile device, the recipient device, to create a venue that provides the functionality described herein. The mother uses the recipient device to create the venue on the server. The mother accesses online vendors, finds the toys or other gifts the child wants, and verifies availability and price. For the gifts that the child desires and wherein availability and price requirements are met in the opinion of the mother, the venue posts those gifts and their price ranges. The venue thereafter displays this information. The mother also enters delivery address information.

The child's mother also provides mobile device numbers of people, referred to herein as donors, who are invited to participate by making purchases of the displayed items. Relatives, for example, may wish to purchase gifts for the child's birthday and have the gifts sent directly to the child, sparing the relatives the added burden of wrapping a gift and traveling to a post office to send the gift.

Once the mother has provided mobile device telephone numbers for donors, the server sends invitations via text message to the donors with notice of the child's upcoming birthday. The potential donors who wish to participate receive their own applications or apps and may then use their apps to access the server. There the donors may view the gifts of interest listed by the child's mother and their prices, make selections for purchase, and provide payment information

The child and/or his mother need not personally contact individual relatives or other parties listed as potential donors. The potential donors, who may be relatives who reside very far from the child, need not contact the child to find out what he wants and risk the problem of misunderstanding the child and purchasing the wrong item which might necessitate a return and refund.

To get started, the recipient device contacts the server and downloads the recipient app. The recipient device uses the locally executing app to create an event on the server with the name of the recipient, the birthday boy in the example above. The recipient device provides other information such as the date of the birthday and the shipping address.

The recipient device then lists items desired and online vendors that sell the items. The recipient device may enter stipulations regarding availability, price, and shipping that must be met by a vendor to sell an item under the created event. The recipient device may provide Internet links for the online vendors.

The recipient device provides mobile numbers of potential donors to be invited. The server sends text messages to the potential donors inviting them to join the event and purchase gifts for the user of the recipient device. If a potential donor responds affirmatively indicating his/her interest in participating, the potential donor may download the donor app.

The donors, having downloaded and installed the donor app on their devices, are given permissions to access the venue created by the recipient device. The donors devices then view the list of gifts created by the recipient device and make purchases.

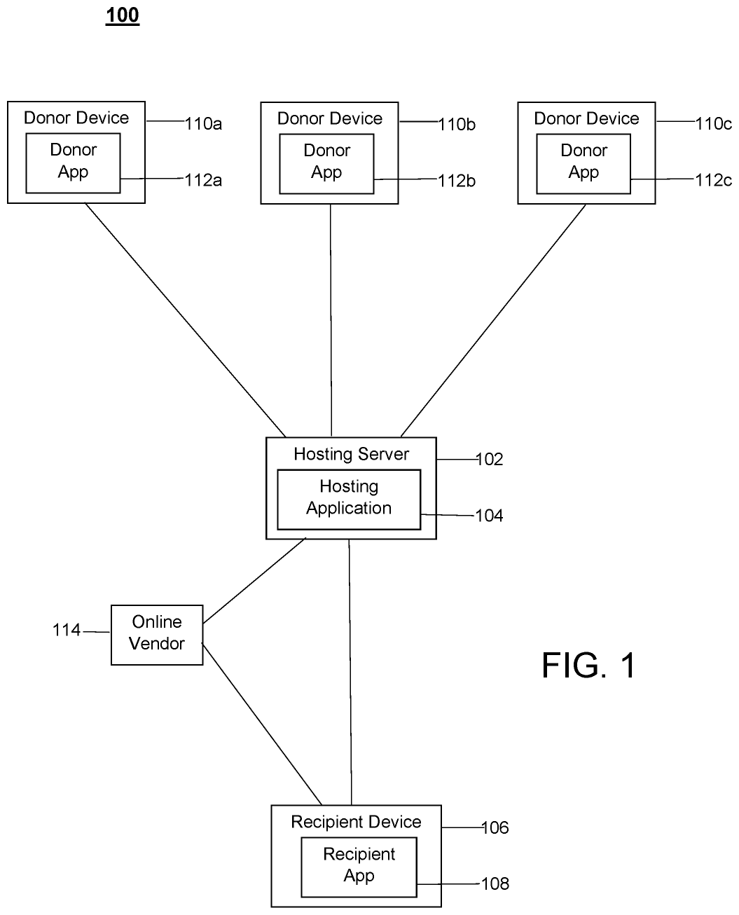

Turning to the FIGURE, FIG. 1 is a block diagram of a system of a My Wish List gift fulfillment in accordance with an embodiment of the present disclosure. Components of a system 100 are depicted.

The system 100 comprises a hosting server 102 and a hosting application 104 executing thereon, referred to for brevity as the server 102 and the application 104, respectively.

The system 100 also comprises the recipient device 106 and the recipient app 108. The system 100 also comprises donor devices 110a-c and donor apps 112a-c. While the system 100 provides and FIG. 1 depicts quantity three donor devices 110a-c and donor apps 112a-c, in embodiments more than or less than quantity three donor devices 110a-c and donor apps 112a-c are in effect.

The system 100 also comprises the online vendor 114. While only one online vendor 114 is shown, in an embodiment many online vendors 114 are in effect. The recipient device 106 deals directly with the online vendor 114 and with the server 102. The server 102 also deals directly with the online vendor 114.

The server 102 may be more than one physical computer situated in more than one geographical location. The application 104 executes on the server 102 and provides much of the functionality described above as being performed by the server.

In embodiments, systems and methods provided herein need not be applicable to gift giving for birthdays but may also apply for baby and wedding shower gifts and wedding gifts. The structure and interactions provided herein may be used in non-gift applications as well.

In embodiments, invitations sent to donor devices may be sent as electronic cards or e-cards. It has been discussed above that donor devices receive original invitations from the server via text message. Such text messages would typically contain invitations in plain text. However, in some embodiments the recipient may direct that donor devices alternatively or additionally receive e-card invitations containing graphics, video and audio content via text message that may be personalized by the recipient for the donor. The e-card invitations may also be sent via electronic mail message if the recipient device provides the server with email addresses of the donors. In the case of email messages to donor devices, the messages may contain selectable links that the donors can activate which indicates their interest in becoming donors.

In some cases, the donor device may be charged additional fees when the donor wishes invitations to be personalized and/or be sent as e-cards containing customized content, graphics and color content, audio content, and/or video content. If the donor wants an option of receiving personalized replies, that option may result in the charging of further fees.

What is claimed is:

1. A system for facilitating acquisition of items on behalf of a requesting device, comprising:
a processor;
a memory; and
an application stored in the memory that when executed on the processor:
publishes a listing of items specified by a first device, the items available from online vendors designated in the specification,
receives an instruction from a second device to purchase a first item in the listing of items,
purchases, based on the instruction, the first item from a first online vendor of the online vendors, and
directs the first online vendor to ship the first item to a specified address.

2. The system of claim 1, wherein the specified address is provided by the first device.

3. The system of claim 1, wherein the system further verifies availability and price of the first item with the first online vendor prior to purchasing.

4. The system of claim 1, wherein the system purchases the first item with payment information provided by the second device.

5. The system of claim 1, wherein the first device invites the second device to purchase at least one of the items available from the online vendors.

6. The system of claim 1, wherein the system publishes the listing in connection with an event for a party associated with the first device.

7. The system of claim 6, wherein an application executing on the first device receives entry of the listing of items, entry of the designated online vendors, entry of guidelines for availability and price of the items, and entry of devices invited to cause purchases of the items for the benefit of the party.

8. A method for facilitating acquisition of items on behalf of a requesting device, comprising:
a mobile device creating a list comprising a description of items desired by a user of the device;
the device qualifying online vendors of the items based on at least one of price, availability, and shipping information;
the device transmitting the list and a description of qualified vendors to a server; and
the device transmitting to the server a listing of parties invited to purchase at least one of the items

9. The method of claim 8, further comprising the server alternatively performing the qualifying of online vendors of the items based on at least one of price, availability, and shipping information.

10. The method of claim 8, further comprising the mobile device providing to the server a recipient address for items purchased by the invited parties.

11. The method of claim 8, further comprising the server receiving an instruction from a first invited party to purchase a first item from the list.

12. The method of claim 11, further comprising the server, based on receipt of the instruction, purchasing the first item from a first qualified vendor.

13. The method of claim 8, further comprising the server purchasing the first item using credit card information provided by the first invited party.

14. The method of claim 8, further comprising the server instructing the first qualified vendor to ship the purchased first item to the recipient address.

15. The method of claim 8, wherein the mobile device creates the list based on selections made at electronic venues of the online vendors.

16. A method of facilitating acquisition of items on behalf of a requesting device, comprising:
a computer publishing a listing of items specified by a first device, the items available from online vendors designated in the specification,
the computer receiving an instruction from a second device to purchase a first item in the listing of items,
the computer purchasing, based on the instruction, the first item from a first online vendor of the online vendors, and
the computer directing the first online vendor to ship the first item to an address specified by the first device.

17. The method of claim 16, wherein the specified address is provided by the first device.

18. The method of claim 16, further comprising the computer purchasing the first item with payment information provided by the second device.

19. The method of claim 16, further comprising the first device inviting the second device to purchase at least one of the items available from the online vendors.

20. The method of claim 16, further comprising an application executing on the first device receiving entry of the listing of items, entry of the designated online vendors, entry of guidelines for availability and price of the items, and entry of devices invited to cause purchases of the items for the benefit of the party.
